(19) United States
(12) Patent Application Publication
(10) Pub. No.: US 2024/0020316 A1
(43) Pub. Date: Jan. 18, 2024

(54) DATA ANALYSIS PROCESSING APPARATUS, DATA ANALYSIS PROCESSING METHOD, AND PROGRAM

(71) Applicant: Nippon Telegraph and Telephone Corporation, Tokyo (JP)

(72) Inventor: Satoru YAGI, Musashino-shi, Tokyo (JP)

(21) Appl. No.: 18/033,733

(22) PCT Filed: Oct. 27, 2020
(86) PCT No.: PCT/JP2020/040212

§ 371 Date: Apr. 25, 2023

(51) Int. Cl. G06F 16/28; G06F 16/21; G06F 16/22

(52) U.S. Cl. CPC G06F 16/283; G06F 16/219; G06F 16/2264

(57) ABSTRACT

A data analysis processing device includes a multidimensional database, a multidimensional database management unit, an OLAP operation execution unit, and a generation history management unit. The multidimensional database accumulates data embodying an event in a multidimensional cube constructed for each subject in association with an event identifier. In the multidimensional cube, the multidimensional database management unit manages data of a time dimension, data of a spatial dimension, data of a plurality of types of intrinsic dimensions, and data representing characteristics of a plurality of types, together with version number information including information of a version number and a configuration of the multidimensional cube. The OLAP operation execution unit executes an OLAP operation on the multidimensional cube in response to a client request. In a case where the multidimensional cube of a new version number is generated by the OLAP operation, the generation history management unit manages generation history information.

### TECHNICAL FIELD

One aspect of the present invention relates to a data analysis processing device, a data analysis processing method, and a program.

### BACKGROUND ART

Real world events change in time, space, or both. That is, an event may be generated, may disappear, or a state thereof may transition. Data representing events can be mapped to multidimensional cubes in the sense of data analysis techniques. A data analysis processing device executes an online analytical processing (OLAP) operation on the multidimensional cube to analyze data (refer to, for example, Non Patent Literature 1 and Non Patent Literature 2).

The data analysis processing device generates the multidimensional cube by capturing data of a certain period on a time series from an information source. The multidimensional cube is updated by capturing data of a new period on the time series from the information source. Here, the generation and update of the multidimensional cube may be either batch processing or real-time processing. Performing an OLAP operation on the multidimensional cube allows for referencing/aggregating data that configures the multidimensional cube and analyzing the data.

### CITATION LIST

### Non Patent Literature

Non Patent Literature 1: R. Kimball (Author), Fujimoto, Okada, Shimohira, Ito, Obata (Translation): Data Warehouse Tool Kit, Chapter 2, Time Dimension, Nikkei BP (1998) Non Patent Literature 2: Kosuke NAKABASAMI, Hiroyuki KITAGAWA, Shaikh, S., A., Toshiyuki AMAGASA: Query optimization method in StreamOLAP, DBS Japanese Journal, Vol. 14-J, No. 3 (2016)

### SUMMARY OF INVENTION

### Technical Problem

In a conventional data analysis processing device, a process of analyzing data is limited. For example, a conventional data analysis processing device accumulates and manages a multidimensional cube generated or updated by fetching data from an information source by batch processing or real-time processing, but does not accumulate and manage a result of operating the multidimensional cube as a new multidimensional cube. Therefore, although the data can be analyzed by functionally manipulating the data, such as referring to/aggregating the data constituting the multidimensional cube, it has not been possible to operate and analyze the data in a history dependent manner, such as processing the data constituting the multidimensional cube, reusing the processed data, and processing the data in stages.

The present invention has been made in view of the above circumstances, and an object of the present invention is to provide a technique capable of analyzing data by operating the data depending on a history.

### Solution to Problem

A data analysis processing device according to an aspect of the present invention includes a multidimensional database, a multidimensional database management unit, an OLAP operation execution unit, and a generation history management unit. The multidimensional database accumulates data embodying a real-world event in a multidimensional cube constructed for each subject in association with an identifier of the event. In the multidimensional cube, the multidimensional database management unit manages data of a time dimension, data of a spatial dimension, data of a plurality of types of intrinsic dimensions, and data representing characteristics of a plurality of types, together with version number information including information of a version number and a configuration of the multidimensional cube. The OLAP operation execution unit executes an online analytical processing (OLAP) operation on the multidimensional cube in response to a request from a client. In a case where the multidimensional cube of a new version number is generated by the OLAP operation, the generation history management unit manages generation history information including information on a process of generating a multidimensional cube of the new version number.

### Advantageous Effects of Invention

According to one aspect of the present invention, it is possible to provide a technology capable of analyzing data by operating the data in a history dependent manner.

### BRIEF DESCRIPTION OF DRAWINGS

FIG. 1 is a functional block diagram illustrating an example of a data analysis processing device according to the present invention.

FIG. 2 is a diagram for illustrating version number information 17.

FIG. 3 is a diagram for illustrating generation history information 13.

FIG. 4 is a sequence diagram illustrating an example of processing in a data analysis processing device 10.

FIG. 5 is a flowchart illustrating an example of a processing procedure of a multidimensional database management unit 15.

FIG. 6 is a diagram illustrating an example of version number information in a case where a multidimensional cube is generated by individually applying conditions to data.

FIG. 7 is a diagram illustrating an example of a processing process of generating the multidimensional cube by individually applying conditions to data.

FIG. 8 is a diagram illustrating an example of a processing process in which the multidimensional database management unit 15 generates and accumulates a multidimensional cube.

FIG. 9 is a diagram illustrating that the multidimensional cubes illustrated in FIGS. 7 and 8 are equivalent.

FIG. 10 is a diagram illustrating an example of version number information in a case where a multidimensional cube is generated by applying a condition to a combination of data pieces.

FIG. 11 is a diagram illustrating an example of a processing process of generating a dimensional cube by applying a condition to a combination of data pieces.

FIG. 12 is a diagram illustrating an example of a processing process in which the multidimensional database management unit 15 generates a multidimensional cube equivalent to that in FIG. 11.

FIG. 13 is a diagram illustrating that the multidimensional cubes illustrated in FIGS. 11 and 12 are equivalent.

FIG. 14 is a diagram illustrating an example of version number information in a case where a multidimensional cube is generated by applying a condition to a combination of data pieces.

FIG. 15 is a diagram illustrating an example of a processing process of generating a dimensional cube by applying a condition to a combination of data pieces.

FIG. 16 is a diagram illustrating an example of a processing process in which the multidimensional database management unit 15 generates a multidimensional cube equivalent to that in FIG. 15.

FIG. 17 is a diagram illustrating that the multidimensional cubes illustrated in FIGS. 15 and 16 are equivalent.

FIG. 18 is a flowchart illustrating an example of a processing procedure of a multidimensional database management unit 15.

FIG. 19 is a diagram illustrating an example of version number information in a case where a missing set is excluded from data constituting a multidimensional cube.

FIG. 20 is a diagram illustrating an example of a process of excluding a missing set from data constituting a multidimensional cube.

FIG. 21 is a block diagram illustrating an example of a hardware configuration of a data analysis processing device according to the present invention.

### DESCRIPTION OF EMBODIMENTS

Hereinafter, embodiments according to the present invention will be described with reference to the drawings.

### Configuration

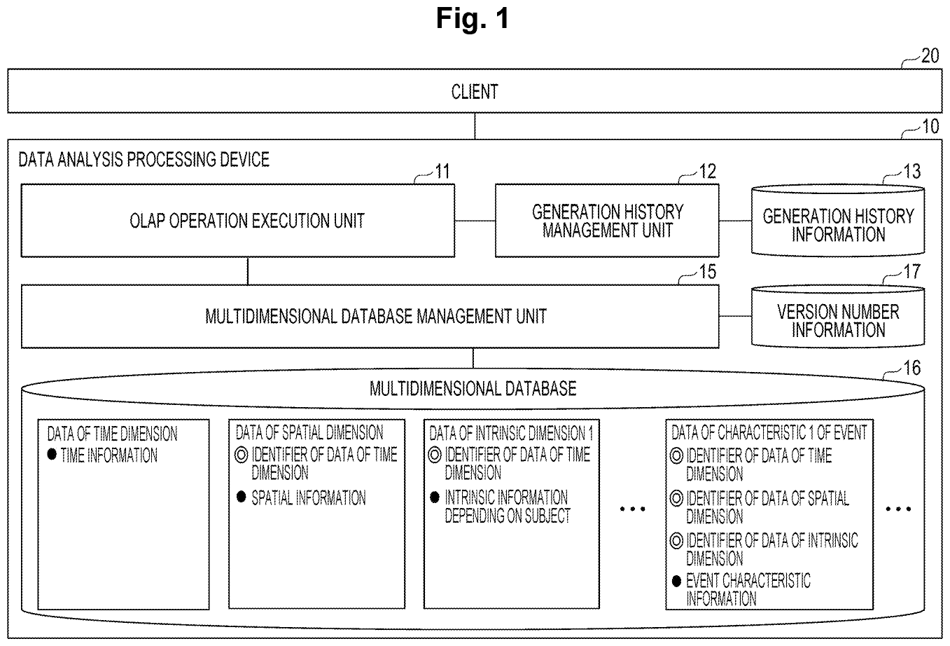

FIG. 1 is a block diagram illustrating an example of a configuration of a data analysis processing device 10 according to the present invention. The data analysis processing device 10 includes an OLAP operation execution unit 11, a generation history management unit 12, generation history information 13, a multidimensional database management unit 15, version number information 17, and a multidimensional database 16.

The multidimensional database 16 accumulates data embodying events in the real world in a multidimensional cube in association with an identifier of an event for identifying an event that is an information source of the data. Multidimensional cubes are constructed for each subject. The accumulated data includes data of a time dimension, data of a spatial dimension, data of a plurality of types of intrinsic dimension, and data representing characteristics of a plurality of types. There are multiple types of intrinsic dimensional data pieces that depend on the subject. Data representing the characteristic is identified by data of a time dimension, a spatial dimension, and an intrinsic dimension. There are multiple types of characteristic data that depend on the subject.

The version number information 17 accumulates identifiers of the multidimensional cube constructed for each subject, version numbers of the multidimensional cube, and sets of identifiers of data representing time dimensions, spatial dimensions, intrinsic dimensions, and characteristics constituting the multidimensional cube. Furthermore, it is also possible to accumulate information describing the configuration as a set.

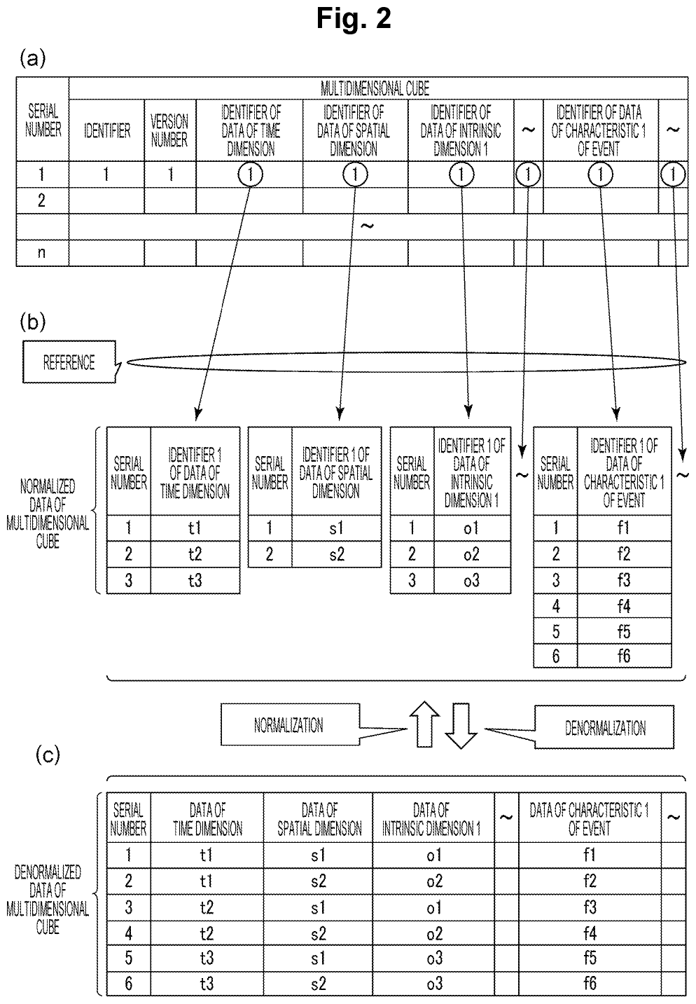

FIG. 2 is a diagram for illustrating the version number information 17. FIG. 2(a) is an example of tabular data for realizing the version number information 17. FIG. 2(b) is an example of tabular data obtained by normalizing data constituting a multidimensional cube, and FIG. 2(c) is an example of tabular data obtained by denormalizing data constituting a multidimensional cube. A serial number 1 in the table of FIG. 2(a) indicates that the multidimensional cube of identifier 1 and version number 1 includes data representing a time dimension, a spatial dimension, an intrinsic dimension, and a characteristic of identifier 1 of FIG. 2(b).

Note that the denormalized primary key in FIG. 2(c) is “data of time dimension, spatial dimension, and intrinsic dimension”. The normalized “data representing characteristics of a plurality of types depending on a subject” in FIG. 2(b) has primary keys of “data of time dimension”, “spatial dimension”, and “intrinsic dimension” as foreign keys. In addition, in order to generate FIG. 2(c) by denormalizing FIG. 2(b), it is only required to join the foreign key included in “data representing characteristics of a plurality of types depending on a subject” and primary keys of “data of time dimension”, “spatial dimension”, and “intrinsic dimension”.

The generation history information 13 accumulates a set of the version number of each multidimensional cube and the executed OLAP operation in a case where a multidimensional cube of a new version number is generated by executing the OLAP operation on the multidimensional cube of a certain version number. Furthermore, it is also possible to accumulate a set of information that explains the OLAP operation.

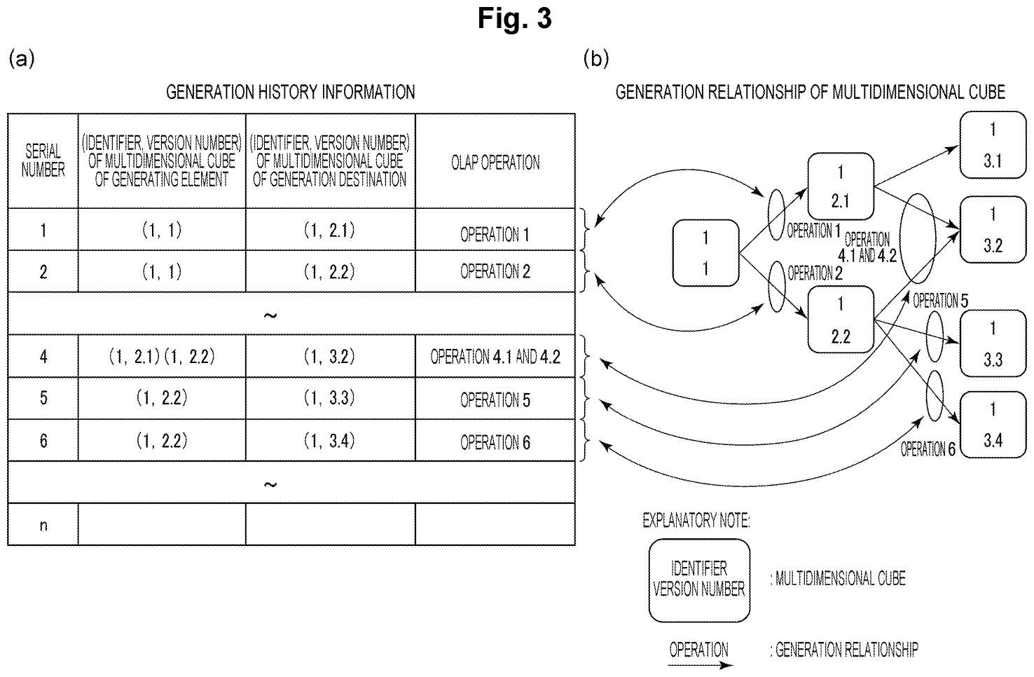

FIG. 3 is a diagram for illustrating generation history information 13. FIG. 3(a) is an example of tabular data for realizing the generation history information 13. FIG. 3(b) is a diagram for illustrating contents of the table of FIG. 3(a). As illustrated in FIG. 3(b), a serial number 1 in the table of FIG. 3(a) indicates that a multidimensional cube with an identifier 1 and a version number 2.1 is generated from a multidimensional cube with an identifier 1 and a version number 1 by an operation 1.

In a case where the OLAP operation is executed on the multidimensional cube of the version number 1, there is a case where the multidimensional cube of the version number 2.1 is generated using an argument an instruction on which is given from a client 20 as an argument of the OLAP operation. Furthermore, there is also a case where data of a new period on the time series is fetched from an information source by batch processing or real-time processing for the multidimensional cube of the version number 1, and the multidimensional cube of the version number 1 is updated to generate the multidimensional cube of the version number 2.1. In this case, the update operation is accumulated instead of the OLAP operation.

As illustrated in FIG. 3(b), a serial number 4 in the table of FIG. 3(a) indicates that a multidimensional cube with an identifier 1 and a version number 3.2 is generated from a multidimensional cube with an identifier 1, a version number 2.1, and a version number 2.2 by an operation 4.1 and an operation 4.2.

In a case of executing the OLAP operation on a multidimensional cube of the version number 2.1, there is a case where a multidimensional cube of the version number 3.2 is generated using data constituting the multidimensional cube of the version number 2.2 as an argument of the OLAP operation. Furthermore, there is also a case where data having an identifier of an event having a relationship such as sum/difference/exclusion is selected for the data constituting the multidimensional cube with the version number 2.1 and the data constituting the multidimensional cube with the version number 2.2 to generate the multidimensional cube with the version number 3.2. In this case, data selection operation is accumulated instead of the OLAP operation.

The OLAP operation execution unit 11 receives the OLAP operation and the arguments transmitted from the client 20, and instructs the multidimensional database management unit 15 to operate the multidimensional data according to the OLAP operation and the arguments. Furthermore, the OLAP operation execution unit 11 receives the operation result of the multidimensional data from the multidimensional database management unit 15, and in a case where a new multidimensional cube is generated and accumulated, transmits a generation history information 13 recording instruction to the generation history management unit 12, and transmits the operation result to the client 20.

The generation history management unit 12 receives the generation history information 13 reference instruction transmitted from the client 20, refers to the generation history information 13, and returns the reference result to the client 20. In addition, the generation history management unit 12 receives the generation history information 13 recording instruction transmitted from the OLAP operation execution unit 11, and generates and accumulates the generation history information 13.

The multidimensional database management unit 15 receives the version number reference instruction transmitted from the client 20, refers to the version number information 17, and returns the reference result to the client 20. In addition, the multidimensional database management unit 15 specifies data to be operated with reference to the version number information 17 in accordance with an instruction from the OLAP operation execution unit 11, and refers to/aggregates the multidimensional data or generates and accumulates the multidimensional data. In addition, in a case where the multidimensional data is generated and accumulated, the multidimensional database management unit 15 generates and accumulates the version number information 17 of a new multidimensional cube configured by the generated and accumulated multidimensional data, and returns the operation result to the OLAP operation execution unit 11.

### Operation

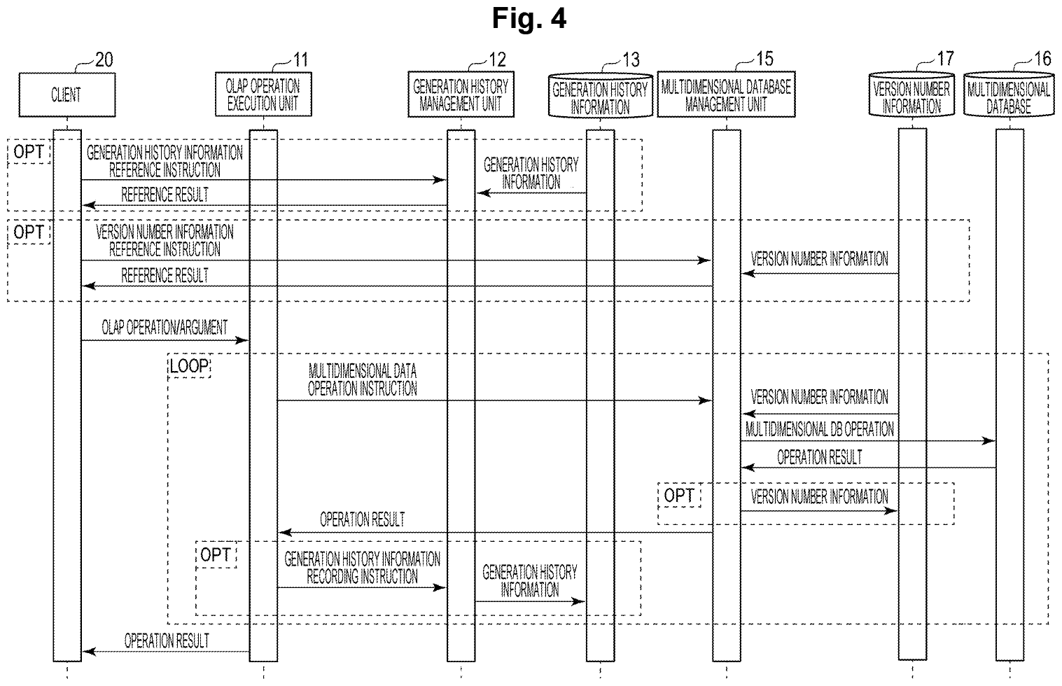

FIG. 4 is a sequence diagram for illustrating an example of the operation of the data analysis processing device 10. In FIG. 4, only when receiving a generation history information 13 reference instruction from the client 20, the generation history management unit 12 refers to the generation history information 13 and returns a reference result to the client 20 (“OPT” enclosed by a broken line in FIG. 4).

Only when receiving the version number information 17 reference instruction from the client 20, the multidimensional database management unit 15 refers to the version number information 17 and returns the reference result to the client 20 (“OPT” enclosed by a broken line in FIG. 4).

When receiving the OLAP operation and the argument from the client 20, the OLAP operation execution unit 11 instructs the multidimensional database management unit 15 to operate the multidimensional data according to the OLAP operation and the argument.

The multidimensional database management unit 15 specifies data to be operated with reference to the version number information 17 in response to an instruction to operate the multidimensional data, and refers to/aggregates the multidimensional data or generates and accumulates the multidimensional data. At this time, only when the multidimensional data is generated and accumulated, the multidimensional database management unit 15 generates and accumulates the version number information 17 of a new multidimensional cube configured by the generated and accumulated multidimensional data (“OPT” enclosed by a broken line in FIG. 4).

The multidimensional database management unit 15 returns an operation result to the OLAP operation execution unit 11. Only when a new multidimensional cube is generated and accumulated, the OLAP operation execution unit 11 transmits the generation history information 13 recording instruction to the generation history management unit 12 (“OPT” enclosed by a broken line in FIG. 4).

Only when the generation history information 13 recording instruction is received from the OLAP operation execution unit 11, the generation history management unit 12 generates and accumulates the generation history information 13 (“OPT” enclosed by a broken line in FIG. 4). The OLAP operation execution unit 11 repeats the instruction to the multidimensional database management unit 15 in accordance with the contents of the received OLAP operation and argument (“LOOP” enclosed by a broken line in FIG. 4). When the final operation result corresponding to the contents of the OLAP operation and the argument can be acquired, the OLAP operation execution unit 11 returns the operation result of the OLAP operation to the client 20.

As described above, in a case where a multidimensional cube of a new version number is generated by executing the OLAP operation on the multidimensional cube of a certain version number, the generation history management unit 12 accumulates and manages a set of the version number of each multidimensional cube and the executed OLAP operation as generation history information representing from which multidimensional cube which multidimensional cube is generated by which OLAP operation.

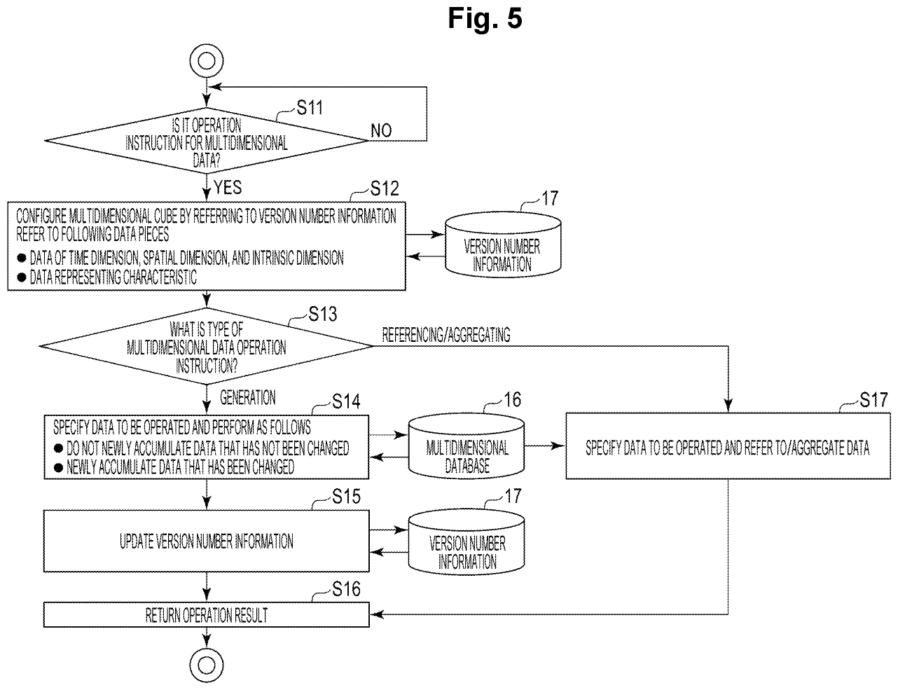

FIG. 5 is a flowchart illustrating an example of a processing procedure of the multidimensional database management unit 15. In FIG. 5, the multidimensional database management unit 15 waits for reception of an operation instruction for multidimensional data from the OLAP operation execution unit 11 (step S11). When receiving the operation instruction, the multidimensional database management unit 15 searches the version number information 17 using the identifier and the version number of the multidimensional cube as keys, and refers to data representing the time dimension, the spatial dimension, the intrinsic dimension, and the characteristic constituting the multidimensional cube (step S12).

Next, the multidimensional database management unit 15 determines the type of the operation instruction (step S13). In the case of referring to/aggregating the multidimensional data, the multidimensional database management unit 15 specifies data to be operated, and refers to/aggregates data representing a time dimension, a spatial dimension, an intrinsic dimension, and a characteristic (step S17).

In the case of generating the multidimensional data, the multidimensional database management unit 15 specifies the data to be operated, and does not change the data representing the time dimension, the spatial dimension, the intrinsic dimension, and the characteristic constituting the multidimensional cube of the existing version number as they are. Then, the multidimensional database management unit 15 newly accumulates data representing the changed time dimension, spatial dimension, intrinsic dimension, and characteristic without newly accumulating data representing the unchanged time dimension, spatial dimension, intrinsic dimension, and characteristic (step S14).

Next, the multidimensional database management unit 15 reflects the reference to the data representing the time dimension, the spatial dimension, the intrinsic dimension, and the characteristic that have not been changed and the reference to the data representing the time dimension, the spatial dimension, the intrinsic dimension, and the characteristic that have been changed in the version number information 17, and manages the data as a multidimensional cube of a new version number (step S15). The multidimensional database management unit 15 returns an operation result to the OLAP operation execution unit 11 (step S16).

Note that the data to be changed and newly accumulated may be data (case 1) obtained by selecting data constituting a multidimensional cube of an existing version number or data (case 2) obtained by calculating data constituting a multidimensional cube of an existing version number.

An example of (case 1) is data that meets the condition. The example of (case 1) is data that meets the condition that data of a time dimension or a spatial dimension is superimposed on a designated period and a designated area. An example of (case 2) is data obtained by calculating data that meets a condition. The example of (case 2) is data obtained by calculating a portion to be overlapped on a designated area for a designated period from data that meets a condition that the data is overlapped on the designated area for a time dimension and a spatial dimension.

As described above, the multidimensional database management unit 15 executes the OLAP operation on the multidimensional cube of a certain version number to refer/aggregate data constituting the multidimensional cube of the existing version number or generate the multidimensional cube of the new version number. In this case, in response to an instruction to operate the multidimensional data, the data to be operated is specified with reference to the version number information 17, and the multidimensional data is referred to/aggregated or the multidimensional data is generated and accumulated. In a case where the multidimensional data is generated and accumulated, the multidimensional database management unit generates and accumulates the version number information 17 of a new multidimensional cube configured by the generated and accumulated multidimensional data.

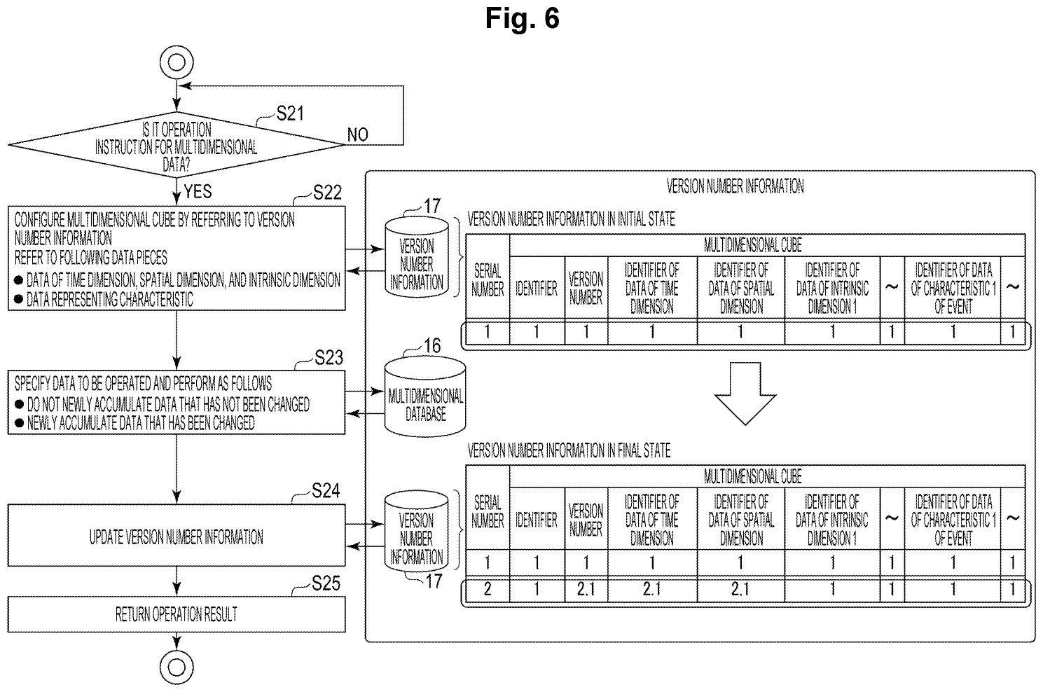

FIG. 6 is a diagram illustrating an example of version number information in a case where a multidimensional cube is generated by individually applying conditions to data. The version number information 17 illustrated in FIG. 6 is an example of the version number information in a case where conditions are individually applied to the data of the time dimension and the spatial dimension for the multidimensional cube of the identifier 1 and the version number 1, the data is individually sorted, and the data is individually changed to generate the multidimensional cube of the identifier 1 and the version number 2.1. Steps S21, S22, S23, S24, and S25 correspond to steps S11, S12, S14, S15, and S16 in FIG. 5.

In FIG. 6, the version number information 17 in the initial state indicates that the data constituting the multidimensional cube with the identifier 1 and the version number 1 is data representing the time dimension, the spatial dimension, the intrinsic dimension, and the characteristic of the identifier 1. The version number information 17 in the final state indicates that the data constituting the multidimensional cube of the identifier 1 and the version number 2.1 is the data of the time dimension and the spatial dimension of the identifier 2.1 and the data representing the intrinsic dimension and the characteristic of the identifier 1.

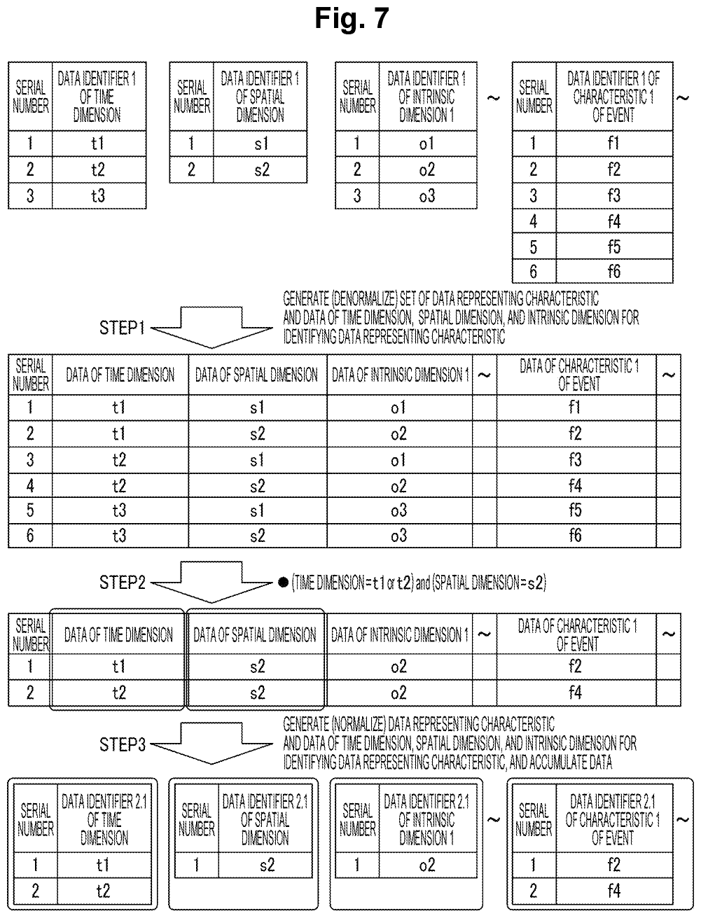

FIG. 7 is a diagram illustrating an example of a processing process of generating the multidimensional cube by individually applying conditions to data. FIG. 7 illustrates an example of a simple processing process in the case of generating a multidimensional cube with the identifier 1 and the version number 2.1 by individually applying conditions to data of a time dimension and a spatial dimension and individually selecting data and individually changing the data for the multidimensional cube with the identifier 1 and the version number 1.

In FIG. 7, a set is generated (denormalized) by the data representing the characteristic and the data of the time dimension, the spatial dimension, and the intrinsic dimension identifying the data representing the characteristic (STEP 1). Next, conditions are individually applied to the data of the time dimension and the spatial dimension in units of sets, and the sets are selected (STEP 2). Next, as a multidimensional cube with the identifier 1 and the version number 2.1, data representing a characteristic and data of a time dimension, a spatial dimension, and an intrinsic dimension for identifying the data representing a characteristic are generated (normalized) and accumulated as data representing the time dimension, the spatial dimension, the intrinsic dimension, and the characteristic of the identifier 2.1 (STEP 3).

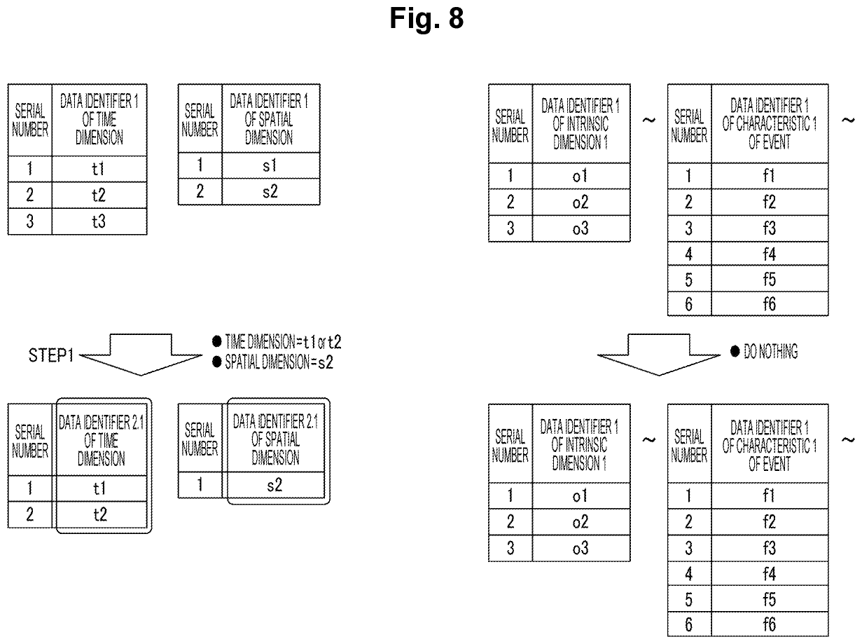

On the other hand, as illustrated in FIG. 8, the multidimensional database management unit 15 individually applies conditions to the data of the time dimension and the spatial dimension, individually selects the data, individually changes the data, and accumulates the data as the data of the time dimension and the spatial dimension of the identifier 2.1. In addition, the multidimensional database management unit 15 generates a multidimensional cube of the identifier 1 and the version number 2.1 by using a reference to data representing the intrinsic dimension and the characteristic of the identifier 1 instead of the data representing the intrinsic dimension and the characteristic of the identifier 2.1. Even in this case, the same result as in the case of simple processing can be obtained.

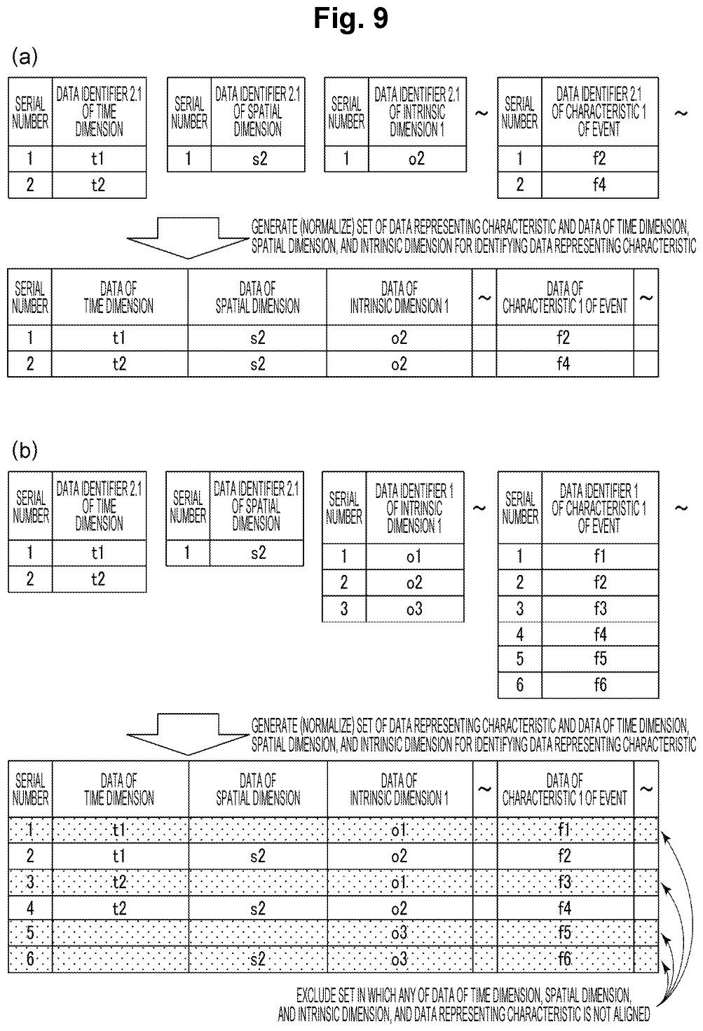

That is, as illustrated in FIG. 9(b), a set equivalent to the set generated (denormalized) with the data representing the characteristic of the identifier 2.1 and the data of the time dimension, the spatial dimension, and the intrinsic dimension of the identifier 2.1 for identifying the data representing the characteristic illustrated in FIG. 9(a) can be generated (denormalized) with the data representing the characteristic of the identifier 1, the data of the time dimension and the spatial dimension of the identifier 2.1 for identifying the data representing the characteristic, and the data of the intrinsic dimension of the identifier 1. At this time, a set in which any of the time dimension data, the spatial dimension data, the intrinsic dimension data, and the data representing the characteristic is not aligned is excluded.

In STEP 3 of FIG. 7, even if only the data representing the characteristic of identifier 2.1 is accumulated, and the reference to the data of the time dimension, the spatial dimension, and the intrinsic dimension of identifier 1 is used instead of the data of the time dimension, the spatial dimension, and the intrinsic dimension of identifier 2.1, a result similar to the case of simple processing can be obtained.

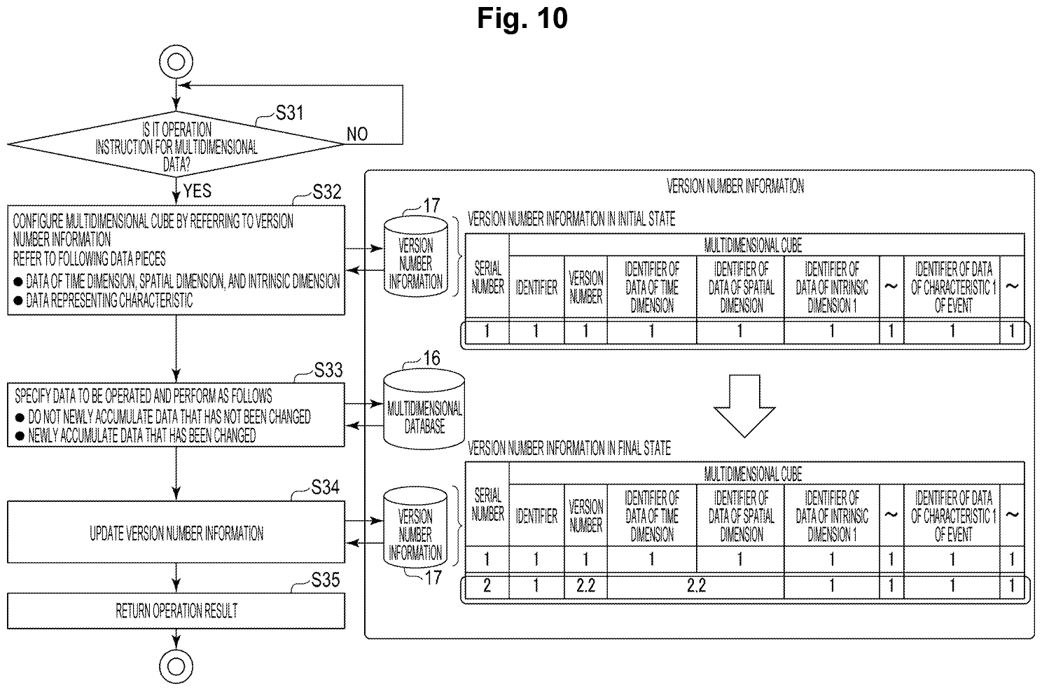

FIG. 10 is a diagram illustrating an example of version number information in a case where a multidimensional cube is generated by applying a condition to a combination of data pieces. The version number information 17 illustrated in FIG. 10 is an example of the version number information in a case where a multidimensional cube of the identifier 1 and the version number 2.2 is generated by applying a condition to a combination of data of a time dimension and data of a space dimension to the multidimensional cube of the identifier 1 and the version number 1, integrally changing the data, and integrally selecting the data. Steps S31, S32, S33, S34, and S35 correspond to steps S11, S12, S14, S15, and S16 in FIG. 5.

In FIG. 10, the version number information 17 in the initial state indicates that the data constituting the multidimensional cube with the identifier 1 and the version number 1 is data representing the time dimension, the spatial dimension, the intrinsic dimension, and the characteristic of the identifier 1. The version number information 17 in the final state indicates that the data constituting the multidimensional cube of the identifier 1 and the version number 2.2 is the data of the time dimension/the spatial dimension of the identifier 2.2 and the data representing the intrinsic dimension and the characteristic of the identifier 1.

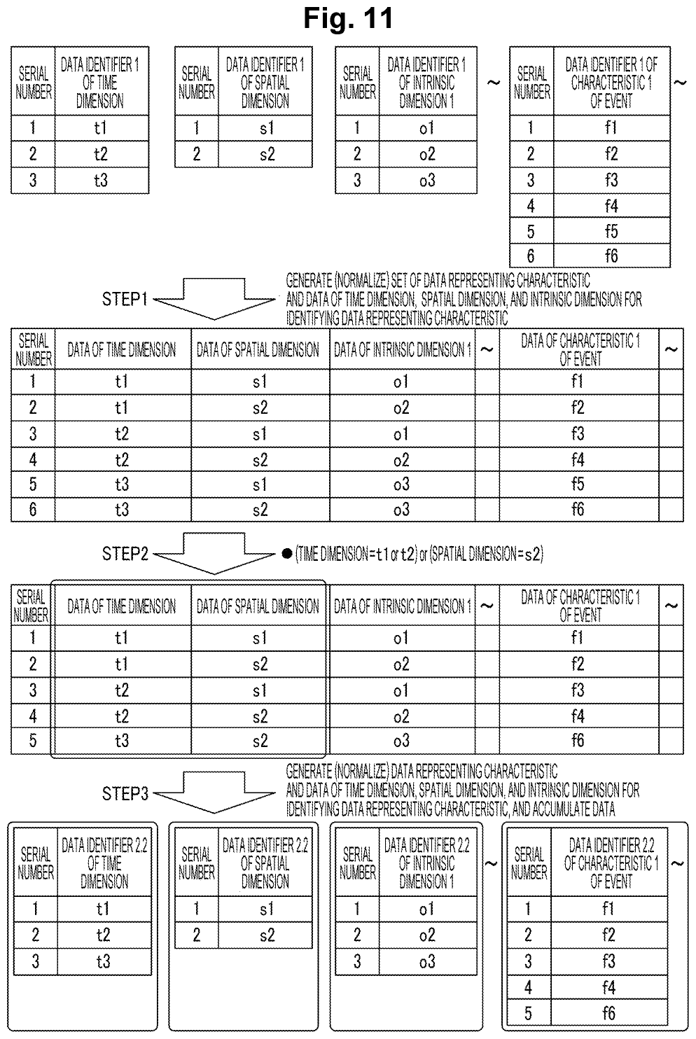

FIG. 11 is a diagram illustrating an example of a processing process of generating a dimensional cube by applying a condition to a combination of data pieces. FIG. 11 illustrates an example of a simple processing process in a case where a condition is applied to a combination of data of a time dimension and data of a spatial dimension with respect to a multidimensional cube of an identifier 1 and a version number 1, the data is integrally selected, and the data is integrally changed to generate a multidimensional cube of the identifier 1 and the version number 2.2.

In FIG. 11, a set is generated (denormalized) by the data representing the characteristic and the data of the time dimension, the spatial dimension, and the intrinsic dimension identifying the data representing the characteristic (STEP 1). Next, a condition is applied to a combination of data of a time dimension and data of a spatial dimension in units of sets, and the sets are selected (STEP 2). Next, as a multidimensional cube with the identifier 1 and the version number 2.2, data representing a characteristic and data of a time dimension, a spatial dimension, and an intrinsic dimension for identifying the data representing the characteristic are generated (normalized) and accumulated as data representing the time dimension, the spatial dimension, the intrinsic dimension, and the characteristic of the identifier 2.2 (STEP 3).

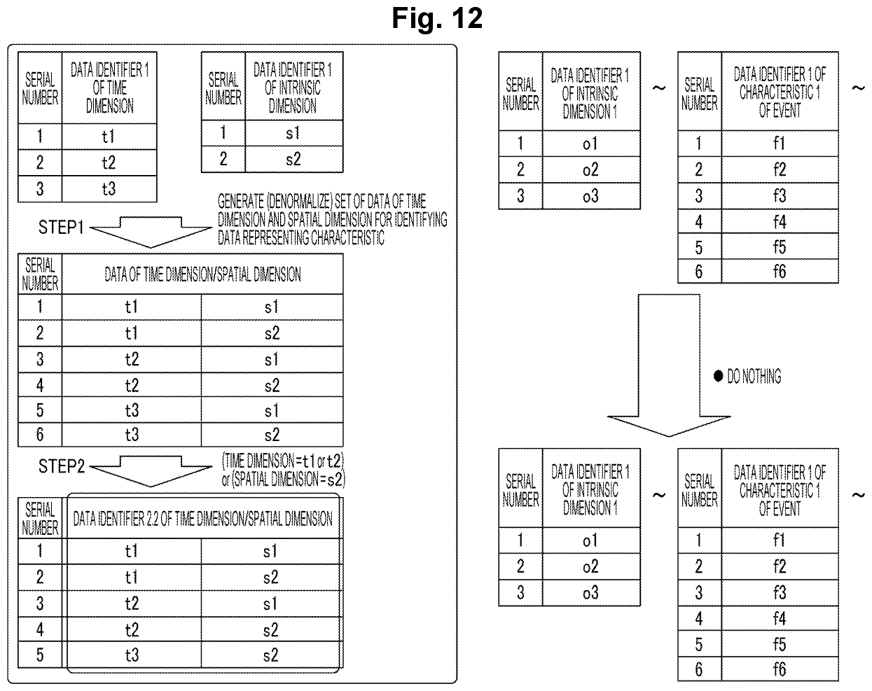

On the other hand, as illustrated in FIG. 12, the multidimensional database management unit 15 applies the condition to the combination of the data of the time dimension and the data of the spatial dimension, selects the data integrally, changes the data integrally, and accumulates the data as the data of the time dimension/the spatial dimension of the identifier 2.2. Then, the multidimensional database management unit 15 generates a multidimensional cube of the identifier 1 and the version number 2.2 by using a reference to data representing the intrinsic dimension and the characteristic of the identifier 1 instead of the data representing the intrinsic dimension and the characteristic of the identifier 2.2. Even in this case, the same result as in the case of simple processing can be obtained.

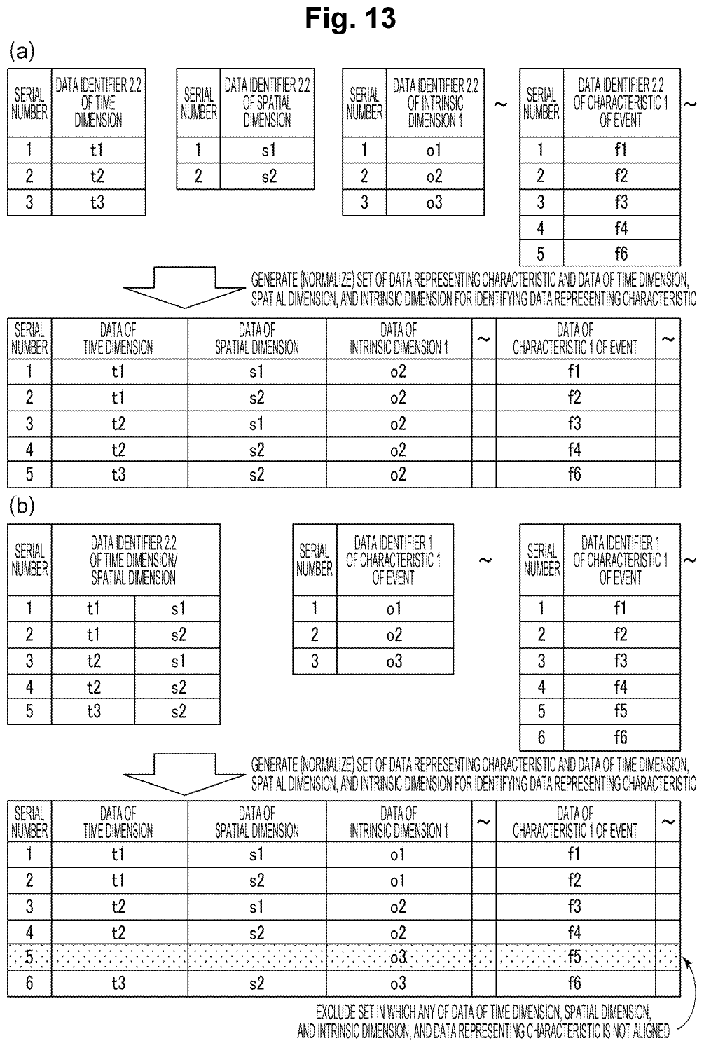

That is, as illustrated in FIG. 13(b), a set equivalent to the set generated (denormalized) with the data representing the characteristic of the identifier 2.2 and the data of the time dimension, the spatial dimension, and the intrinsic dimension of the identifier 2.2 for identifying the data representing the characteristic illustrated in FIG. 13(a) can be generated (denormalized) with the data representing the characteristic of the identifier 1, the data of the time dimension/the spatial dimension of the identifier 2.2 for identifying the data representing the characteristic, and the data of the intrinsic dimension of the identifier 1. At this time, a set in which any of the time dimension data, the spatial dimension data, the intrinsic dimension data, and the data representing the characteristic is not aligned is excluded.

Similarly, in STEP 3 of FIG. 11, even if only the data representing the characteristic of identifier 2.2 is accumulated, and the reference to the data of the time dimension, the spatial dimension, and the intrinsic dimension of identifier 1 is used instead of the data of the time dimension, the spatial dimension, and the intrinsic dimension of identifier 2.2, a result similar to the case of simple processing can be obtained.

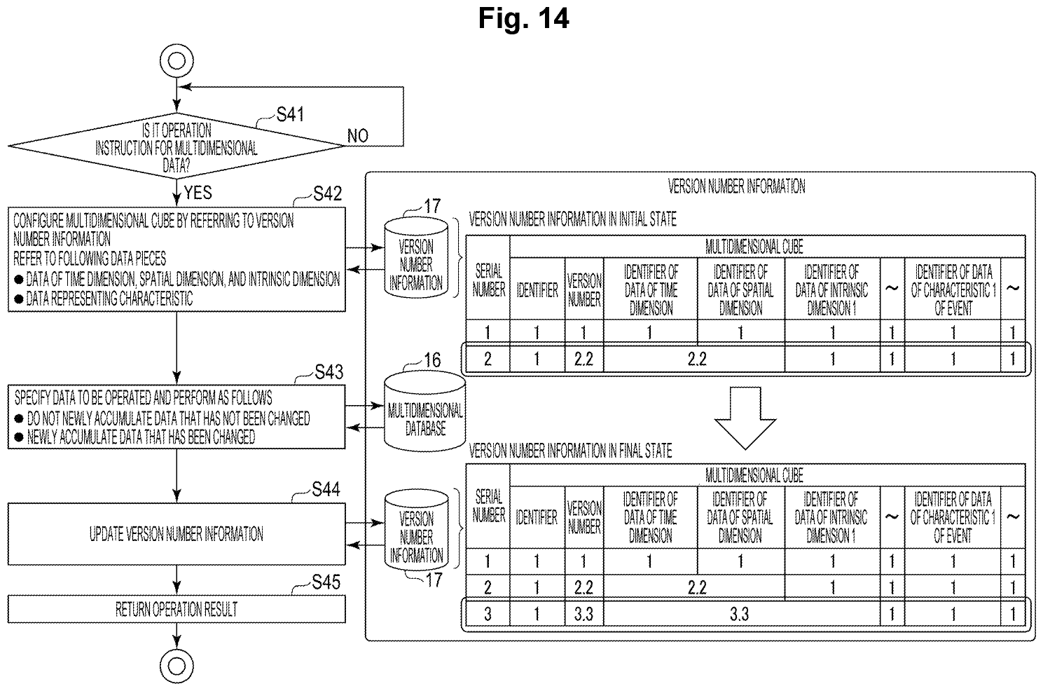

FIG. 14 is a diagram illustrating an example of version number information in a case where a multidimensional cube is generated by applying a condition to a combination of data pieces. FIG. 14 illustrates an example of the version number information 17 in a case where a multidimensional cube of the identifier 1 and the version number 3.3 is generated by applying a condition to a combination of data of a spatial dimension and data of an intrinsic dimension 1 to the multidimensional cube of the identifier 1 and the version number 2.2, integrally selecting the data, and integrally changing the data. Steps S41, S42, S43, S44, and S45 correspond to steps S11, S12, S14, S15, and S16 in FIG. 5.

In FIG. 14, the version number information 17 in the initial state indicates that the data constituting the multidimensional cube of the identifier 1 and the version number 2.2 is the data of the time dimension/the spatial dimension of the identifier 2.2 and the data representing the intrinsic dimension and the characteristic of the identifier 1. The version number information 17 in the final state indicates that the data constituting the multidimensional cube of the identifier 1 and the version number 3.3 is the data of the time dimension/spatial dimension/intrinsic dimension 1 of the identifier 3.3 and the data representing the characteristic of the intrinsic dimension 2, and its subsequent dimensions of the identifier 1.

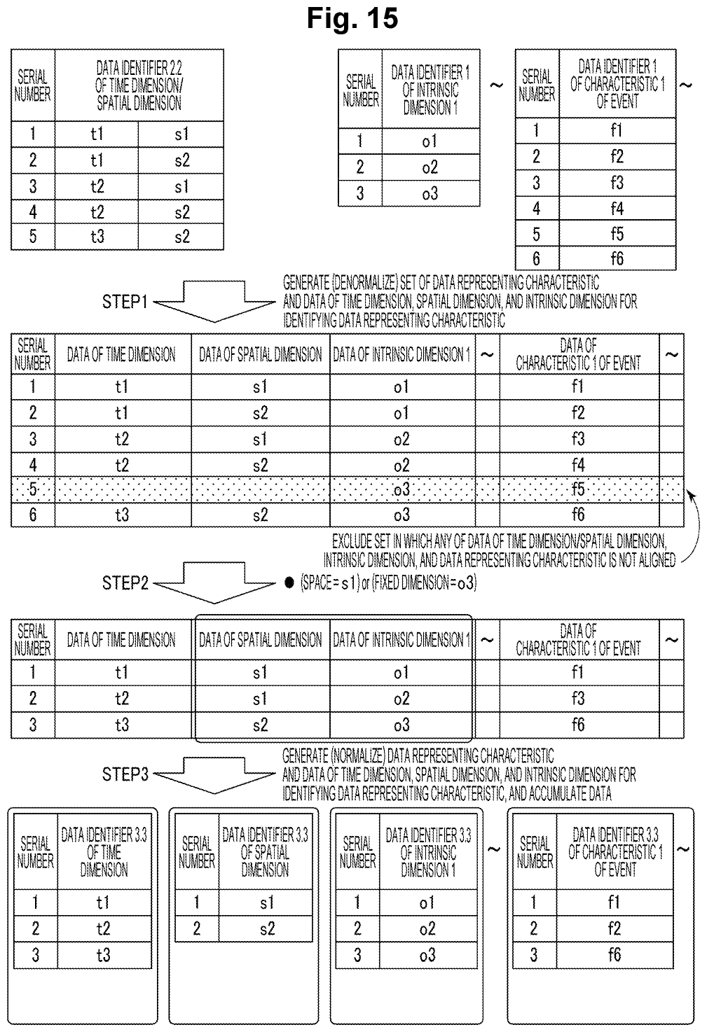

FIG. 15 is a diagram illustrating an example of a processing process of generating a dimensional cube by applying a condition to a combination of data pieces. FIG. 15 illustrates an example of a simple processing process in a case where a condition is applied to a combination of data of a spatial dimension and data of an intrinsic dimension 1 with respect to a multidimensional cube of an identifier 1 and a version number 2.2, the data is integrally selected, and the data integrally is changed to generate a multidimensional cube of the identifier 1 and the version number 3.3.

In FIG. 15, a set is generated (denormalized) by the data representing the characteristic and the data of the time dimension, the spatial dimension, and the intrinsic dimension identifying the data representing the characteristic (STEP 1). Next, a condition is applied to a combination of the data of the spatial dimension and the data of the intrinsic dimension 1 in units of sets, and the sets are selected (STEP 2). Next, as a multidimensional cube with the identifier 1 and the identifier 3.3, data representing a characteristic and data of a time dimension, a spatial dimension, and an intrinsic dimension for identifying the data representing the characteristic are generated (normalized) and accumulated as data representing the time dimension, the spatial dimension, the intrinsic dimension, and the characteristic of the identifier 3.3 (STEP 3).

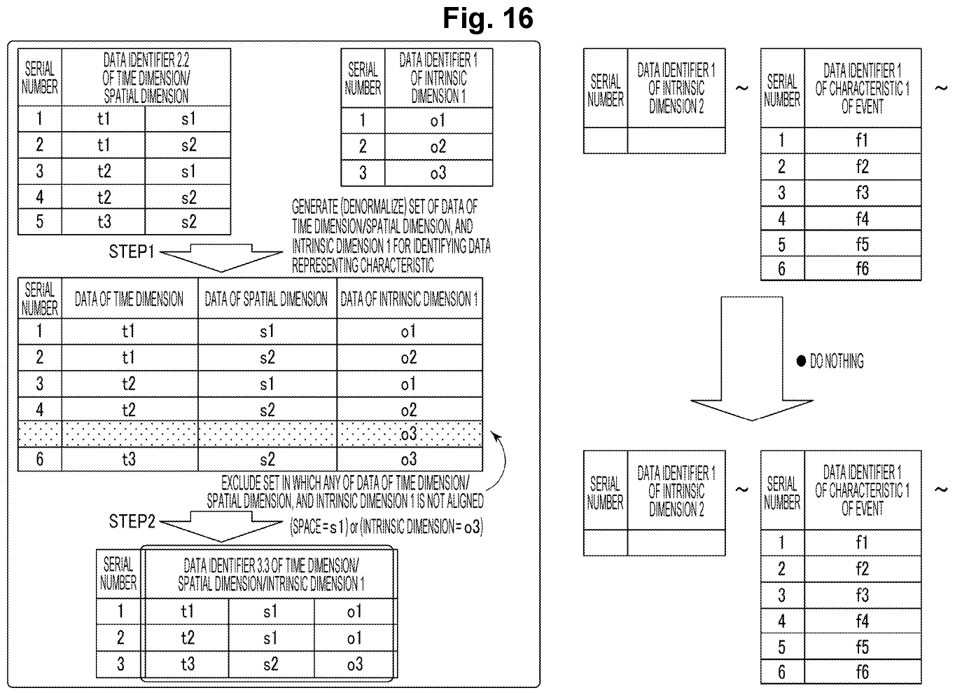

On the other hand, as illustrated in FIG. 16, the multidimensional database management unit 15 applies a condition to the combination of the data of the time dimension/spatial dimension and the data of the intrinsic dimension 1, and selects the data as one unit. Then, the multidimensional database management unit 15 integrally changes and accumulates the data as the data of the time dimension/spatial dimension/intrinsic dimension 1 of the identifier 3.3, and generates the multidimensional cube of the identifier 1 and the version number 3.3 using the reference to the data representing the intrinsic dimension 2 and its subsequent dimensions of the identifier 1 and the characteristic instead of the intrinsic dimension 2 and its subsequent dimensions of the identifier 3.3 and the data representing the characteristic. Even in this case, the same result as in the case of simple processing can be obtained.

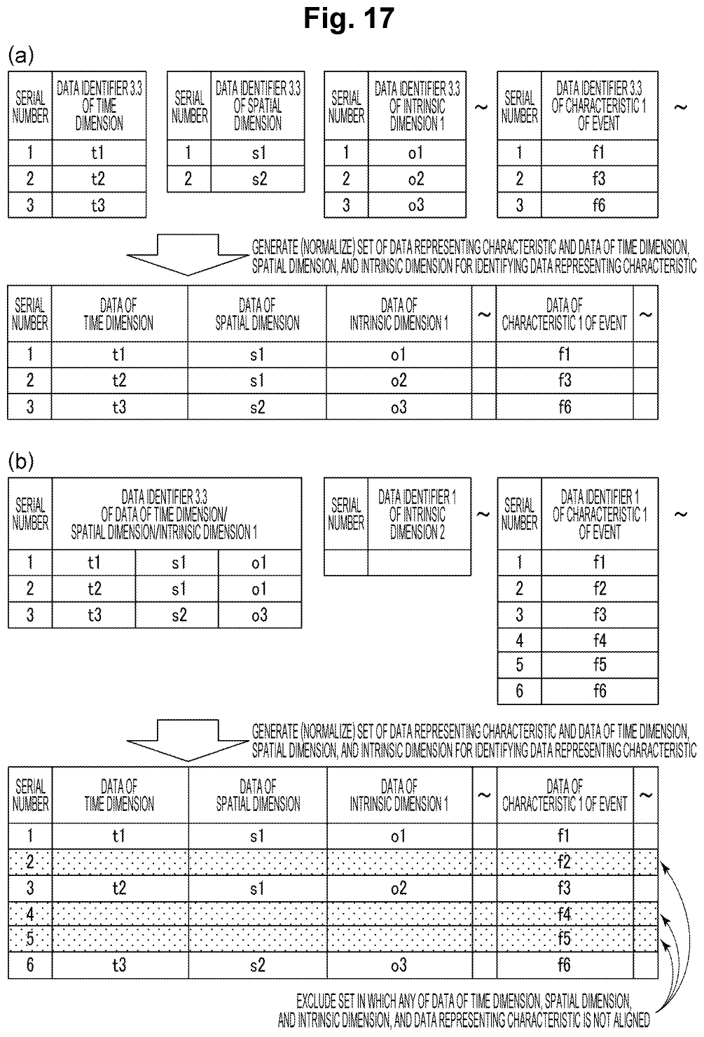

That is, as illustrated in FIG. 17(b), a set equivalent to the set generated (denormalized) with the data representing the characteristic of the identifier 3.3 and the data of the time dimension, the spatial dimension, and the intrinsic dimension of the identifier 3.3 for identifying the data representing the characteristic illustrated in FIG. 17(a) can be generated (denormalized) with the data representing the characteristic of the identifier 1, the data of the time dimension/the spatial dimension/the intrinsic dimension 1 of the identifier 3.3 for identifying the data representing the characteristic, and the data of the intrinsic dimension 2 and its subsequent dimensions of the identifier 1. At this time, a set in which any of the time dimension data, the spatial dimension data, the intrinsic dimension data, and the data representing the characteristic is not aligned is excluded.

In STEP 3 of FIG. 15, even if only the data representing the characteristic of identifier 3.3 is accumulated, and the reference to the data of the time dimension, the spatial dimension, and the intrinsic dimension of identifier 1 is used instead of the data of the time dimension, the spatial dimension, and the intrinsic dimension of identifier 3.3, a result similar to the case of simple processing can be obtained.

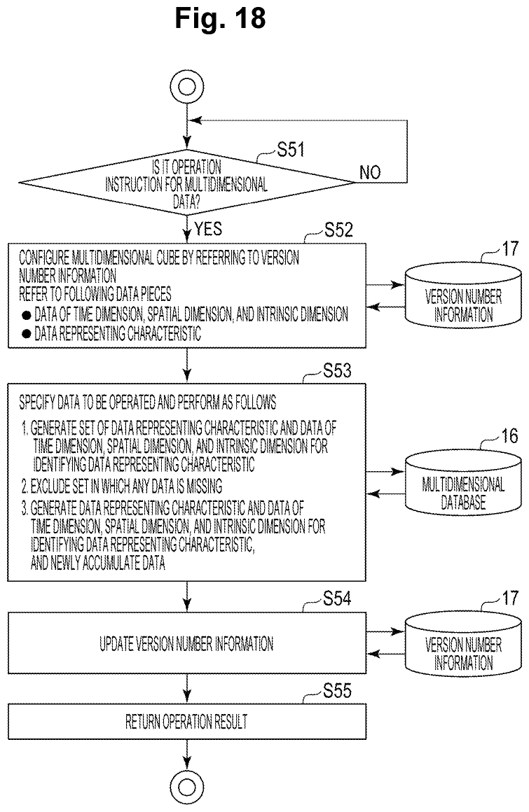

FIG. 18 is a flowchart illustrating an example of a processing procedure of the multidimensional database management unit 15. In FIG. 18, the multidimensional database management unit 15 waits for reception of an operation instruction for multidimensional data from the OLAP operation execution unit 11 (step S51). When receiving the operation instruction, the multidimensional database management unit 15 searches the version number information 17 using the identifier and the version number of the multidimensional cube as keys, and refers to data representing the time dimension, the spatial dimension, the intrinsic dimension, and the characteristic constituting the multidimensional cube (step S52).

Next, the multidimensional database management unit 15 specifies the data to be operated, and generates (denormalizes) a set of the data representing the characteristic and the data of the time dimension, the spatial dimension, and the intrinsic dimension for identifying the data representing the characteristic constituting the multidimensional cube. Then, in a case where there is a set in which any data is missing, the multidimensional database management unit 15 excludes the set, generates (normalizes) the data representing the characteristic and the data of the time dimension, the spatial dimension, and the intrinsic dimension for identifying the data representing the characteristic, and newly accumulates the data (step S53). Next, the multidimensional database management unit 15 reflects the reference to the newly accumulated data representing the time dimension, the spatial dimension, the intrinsic dimension, and the characteristic in the version number information 17 and manages the data as a multidimensional cube of a new version number (step S54). The multidimensional database management unit 15 returns an operation result to the OLAP operation execution unit 11 (step S55).

As described above, in a case where data constituting a multidimensional cube of an existing version number is referred/aggregated or a multidimensional cube of a new version number is generated by executing the OLAP operation on a multidimensional cube of a certain version number, the multidimensional database management unit 15 specifies data to be operated with reference to the version number information 17 in response to an operation instruction of the multidimensional data as preprocessing, post-processing, or independent processing to be arbitrarily executed. Then, when the data representing the characteristic and the data of the time dimension, the spatial dimension, and the intrinsic dimension for identifying the data representing the characteristic constituting the multidimensional cube are combined, in a case where there is a set in which any data is missing, the multidimensional database management unit 15 excludes the set. Then, the multidimensional database management unit 15 generates and accumulates data representing the characteristic and data of a time dimension, a spatial dimension, and an intrinsic dimension for identifying the data representing the characteristic, and generates and accumulates version number information 17 of a new multidimensional cube configured by the generated and accumulated multidimensional data.

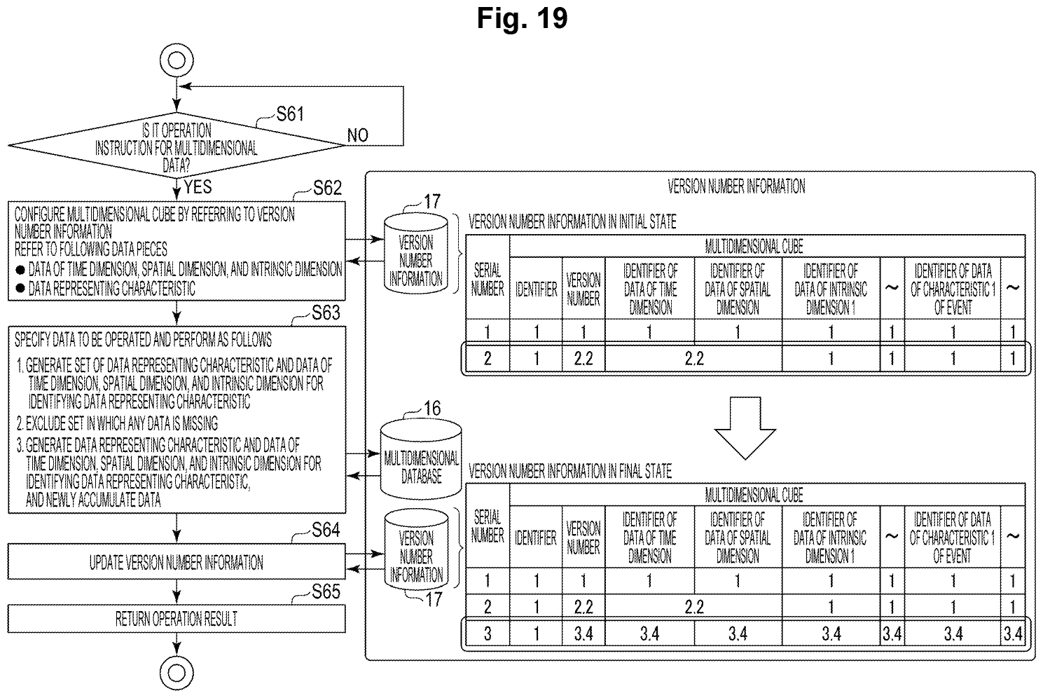

FIG. 19 is a diagram illustrating an example of version number information in a case where a missing set is excluded from data constituting a multidimensional cube. FIG. 19 illustrates an example of the version number information 17 in a case where a set is generated (denormalized) by the data representing the characteristic and the data of the time dimension, the spatial dimension, and the intrinsic dimension for identifying the data representing the characteristic for the multidimensional cube of the identifier 1 and the version number 2.2, and in a case where there is a set in which any data is missing, the set is excluded and the multidimensional cube of the identifier 1 and the version number 3.4 is generated. Steps S61, S62, S63, S64, and S65 correspond to steps S51, S52, S53, S54, and S55 in FIG. 18.

In FIG. 19, the version number information 17 in the initial state indicates that the data constituting the multidimensional cube of the identifier 1 and the version number 2.2 is the data of the time dimension/the spatial dimension of the identifier 2.2 and the data representing the intrinsic dimension and the characteristic of the identifier 1. The version number information 17 in the final state indicates that the data constituting the multidimensional cube with the identifier 1 and the version number 3.4 is data representing the time dimension, the spatial dimension, the intrinsic dimension, and the characteristic of the identifier 3.4.

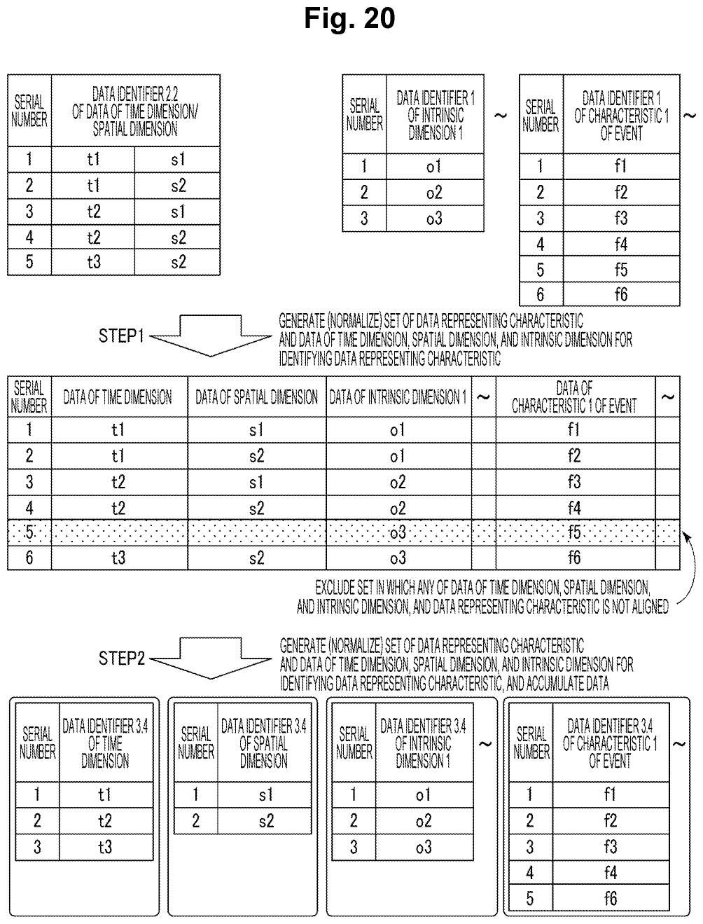

FIG. 20 is a diagram illustrating an example of a process of excluding a missing set from data constituting a multidimensional cube. In FIG. 20, a set is generated (denormalized) by the data representing the characteristic and the data of the time dimension, the spatial dimension, and the intrinsic dimension identifying the data representing the characteristic (STEP 1). At this time, a set in which any of the data representing the time dimension, the spatial dimension, the intrinsic dimension, and the characteristic is missing is excluded. Next, as a multidimensional cube with the identifier 1 and the version number 3.4, data representing a characteristic and data of a time dimension, a spatial dimension, and an intrinsic dimension for identifying the data representing the characteristic are generated (normalized) and accumulated as data representing the time dimension, the spatial dimension, the intrinsic dimension, and the characteristic of the identifier 3.4 (STEP 2).

As described above, a set of data representing the characteristic and data of the time dimension, the spatial dimension, and the intrinsic dimension for identifying the data representing the characteristic is generated (denormalized) for the multidimensional cube of the identifier 1 and the version number 2.2, and in a case where there is a set in which any data is missing, the multidimensional cube of the identifier 1 and the version number 3.4 is generated by excluding the set.

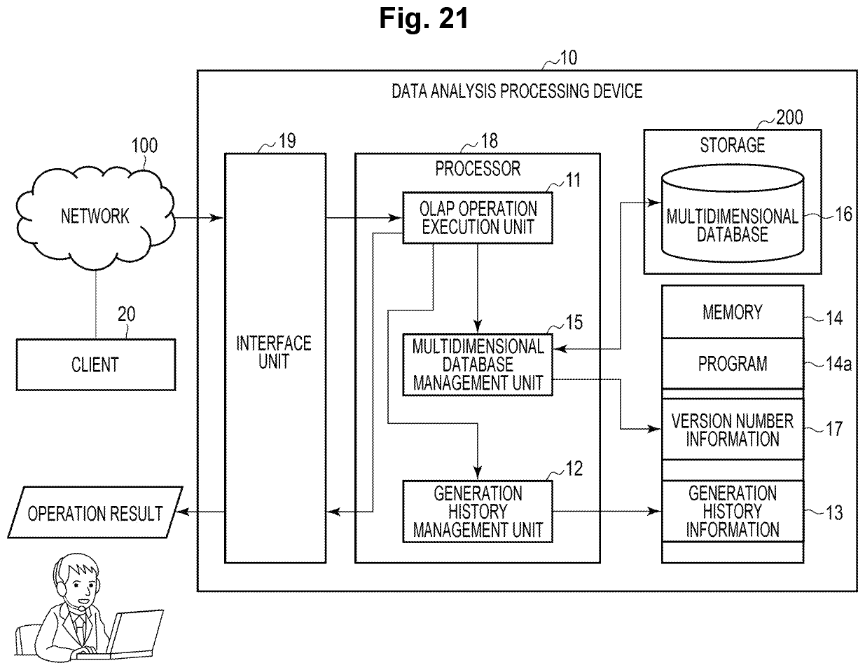

FIG. 21 is a block diagram illustrating an example of a hardware configuration of a data analysis processing device according to the present invention. In FIG. 21, the data analysis processing device 10 includes a processor 18, a storage 200 that stores the multidimensional database 16, an interface unit 19, and a memory 14. That is, the data analysis processing device 10 is a computer, and is realized as, for example, a personal computer, a server computer, or the like.

The interface unit 19 is connected to the network 100 and receives access from the client 20 connected to the network 100.

The storage 200 is, for example, a non-volatile storage medium (block device) such as a hard disk drive (HDD) or a solid state drive (SSD). The storage 200 stores the multidimensional database 16 in addition to a basic program such as an operating system (OS) or a device driver, a program for realizing the function of the data analysis processing device 10, and the like.

The memory 14 of FIG. 21 is, for example, a random access memory (RAM), and stores version number information 17 and generation history information 13 in addition to the program 14a loaded from the storage 200 and various data.

Moreover, the processor 18 in FIG. 21 is an arithmetic unit such as a central processing unit (CPU) or a micro processing unit (MPU), and implements the functions thereof by the program loaded in the memory 14.

Meanwhile, the processor 18 includes an OLAP operation execution unit 11, a multidimensional database management unit 15, and a generation history management unit 12 as processing functions according to the embodiment. The OLAP operation execution unit 11, the multidimensional database management unit 15, and the generation history management unit 12 are processing functions implemented by the processor 18 executing instructions included in a program 14a. That is, the data analysis processing device 10 of the present invention can also be realized by a computer and a program. In addition to recording and distributing the program on a recording medium such as an optical medium, it is also possible to provide the program through the network.

Note that the OLAP operation execution unit 11, the multidimensional database management unit 15, and the generation history management unit 12 may be realized in other various forms including an integrated circuit such as an application specific integrated circuit (ASIC) or a field-programmable gate array (FPGA) instead of or in addition to the processor 18.

The processor 18 can receive the OLAP operation and arguments from the client 20 via the interface unit 19, and can transmit an operation result to the client 20.

### Effects

The data analysis processing device 10 includes the version number information 17 that accumulates identifiers of multidimensional cubes constructed for each subject, version numbers of the multidimensional cubes, and a set of identifiers of data representing time dimensions, spatial dimensions, intrinsic dimensions, and characteristics constituting the multidimensional cube, and the generation history information 13 that accumulates the version numbers of each multidimensional cube and the set of executed OLAP operations when generating a multidimensional cube of a new version number by executing the OLAP operation on a multidimensional cube of a certain version number. Then, the data analysis processing device 10 provides the generation history information 13/version number information 17 in response to a request from the client 20, and executes the OLAP operation on the multidimensional cube of the version number designated by the client 20. Further, in a case of generating and accumulating multidimensional data, the data analysis processing device generates and accumulates generation history information 13/version number information 17 of a new multidimensional cube configured by the generated and accumulated multidimensional data.

As described above, in a case where the multidimensional data is generated and accumulated, the generation history information 13/version number information 17 of a new multidimensional cube configured by the generated and accumulated multidimensional data is generated and accumulated, whereby the data obtained by processing the data constituting the multidimensional cube can be reused. In addition, the generation history information 13/version number information 17 is provided in response to a request from the client 20, and the OLAP operation is executed on the multidimensional cube of the version number designated by the client 20, whereby the data constituting the multidimensional cube can be processed in stages.

Therefore, the data constituting the multidimensional cube can be processed, the processed data can be reused, and the data can be analyzed by being operated in a history dependent manner, such as being processed in stages.

Furthermore, in the embodiment, in a case of generating a new version number of a multidimensional cube, the multidimensional database management unit 15 generates (denormalizes) a set of data representing the characteristics and data of the time dimension, the spatial dimension, and the intrinsic dimension that identify the data representing the characteristics by performing an OLAP operation on a multidimensional cube of a certain version number, applies conditions to the data in units of sets and operates the sets to generate (normalize) data representing the characteristics and data of the time dimension, the spatial dimension, and the intrinsic dimension for identifying the data representing the characteristics, and executes a processing process in which only the data to which the condition is applied is operated from the data representing the time dimension, the spatial dimension, the intrinsic dimension, and the characteristic, and only the operated data is newly accumulated instead of the simple process of newly accumulating.

As described above, by executing the OLAP operation on the multidimensional cube of a certain version number, in a case where the multidimensional cube of a new version number is generated, the data to be operated can be limited to the data to which the condition is applied, and the data to be accumulated can be limited to the data to be operated.

Therefore, it is possible to suppress the data processing amount and the storage capacity required in the case of generating a multidimensional cube of a new version number by executing the OLAP operation on the multidimensional cube of a certain version number.

In addition, in the embodiment, the multidimensional database management unit 15 executes the OLAP operation on the multidimensional cube of a certain version number to refer/aggregate data constituting the multidimensional cube of the existing version number or generate the multidimensional cube of the new version number. In this case, the multidimensional database management unit 15 generates (denormalizes) a set of data representing characteristics and data of a time dimension, a spatial dimension, and an intrinsic dimension for identifying the data representing characteristics constituting the multidimensional cube, as preprocessing, post-processing, or independent processing to be arbitrarily executed. Then, in a case where there is a set in which any data is missing, the multidimensional database management unit 15 excludes the set, generates (normalizes) data representing the characteristic and data of the time dimension, the spatial dimension, and the intrinsic dimension for identifying the data representing the characteristic, newly accumulates the data pieces, reflects the reference to the newly accumulated data representing the time dimension, the spatial dimension, the intrinsic dimension, and the characteristic in the version number information 17, and manages the data as a multidimensional cube of a new version number.

In this manner, when the data representing the characteristic and the data of the time dimension, the spatial dimension, and the intrinsic dimension for identifying the data representing the characteristic are combined as a set, it is possible to generate and accumulate a multidimensional cube of a new version number in which there is no set in which any data is missing. Therefore, when data representing a characteristic and data of a time dimension, a spatial dimension, and an intrinsic dimension for identifying the data representing the characteristic are combined as a set each time the data constituting the multidimensional cube of the existing version number is referred to/aggregated or the multidimensional cube of the new version number is generated by executing the OLAP operation on the multidimensional cube of a certain version number, in a case where there is a combination in which any data is missing, processing of excluding the combination can be made unnecessary.

Therefore, according to the embodiment, it is possible to provide a data analysis processing device, a data analysis processing method, and a program that enable data to be analyzed by manipulating the data in a history dependent manner, such as processing the data constituting the multidimensional cube, reusing the processed data, and processing the data in stages.

Note that, the present invention is not limited to the embodiments stated above, and at the implementation stage, the constituent elements can be modified and implemented without departing from the gist of the invention. Various inventions can be formed by appropriately combining a plurality of the constituent elements disclosed in the embodiments stated above. For example, some constituent elements may be omitted out of all the constituent elements described in the embodiments. Moreover, the constituent elements in the different embodiments may be appropriately combined.

### REFERENCE SIGNS LIST

10 Data analysis processing device

11 OLAP operation execution unit

12 Generation history management unit

13 Generation history information

14 Memory

14a Program

15 Multidimensional database management unit

16 Multidimensional database

17 Version number information

18 Processor

19 Interface unit

20 Client

100 Network

200 Storage

1. A data analysis processing device comprising:
a multidimensional database for accumulating data pieces embodying a real-world event in a multidimensional cube constructed for each subject in association with an identifier of the event; and
one or more processors configured to execute instructions that cause the data analysis processing device to perform operations comprising:
managing, in the multidimensional cube, data of a time dimension, data of a spatial dimension, data of a plurality of types of intrinsic dimensions, and data representing characteristics of a plurality of types together with version number information including information of a version number and a configuration of the multidimensional cube;
executing an online analytical processing (OLAP) operation on the multidimensional cube in response to a request from a client; and
managing generation history information including information on a process of generating a multidimensional cube of a new version number in a case where the multidimensional cube of the new version number is generated by the OLAP operation.

2. The data analysis processing device according to claim 1, wherein, in a case where the OLAP operation is executed on the multidimensional cube of a certain version number, the one or more processors are configured to use an argument an instruction on which is given from the client as an argument of the OLAP operation or data constituting the multidimensional cube of another version number to refer to/aggregate data constituting the multidimensional cube of an existing version number or generate the multidimensional cube of the new version number.

3. The data analysis processing device according to claim 1, wherein, in a case where the multidimensional cube of a new version number is generated, the one or more processors are configured to include information representing which multidimensional cube is generated from which multidimensional cube and which OLAP operation is used to generate a set of a version number of each multidimensional cube and the executed OLAP operation in the generation history information by executing the OLAP operation on the multidimensional cube of a certain version number.

4. The data analysis processing device according to claim 1, wherein, in a case of generating a multidimensional cube of a new version number by executing the OLAP operation on a multidimensional cube of a certain version number, the one or more processors are configured to:
not change data representing a time dimension, a spatial dimension, an intrinsic dimension, and a characteristic included in the multidimensional cube of the existing version number,
not newly accumulate data representing the time dimension, the spatial dimension, the intrinsic dimension, and the characteristic that have not been changed,
newly accumulate data representing the changed time dimension, the spatial dimension, the intrinsic dimension, and the characteristic,
reflect reference to the data representing the time dimension, the spatial dimension, the intrinsic dimension, and the characteristic that have not been changed and the reference to the data representing the changed time dimension, the spatial dimension, the intrinsic dimension, and the characteristic in the version number information, and
manage the data as the multidimensional cube of the new version number.

5. The data analysis processing device according to claim 1, wherein, when referencing/aggregating the data constituting the multidimensional cube of the existing version number or generating a multidimensional cube of a new version number, the one or more processors are configured to:
generate a set of data representing characteristics and data of a time dimension, a spatial dimension, and an intrinsic dimension for identifying data representing characteristics configuring the multidimensional cube as preprocessing, post-processing, or independent processing to be arbitrarily executed by executing the OLAP operation on the multidimensional cube of a certain version number,
if there is a set that is missing any data, exclude the set,
generate and newly accumulate data representing characteristics and data in time dimension, spatial dimension, and intrinsic dimension that identify the data representing characteristics,
reflect reference to the data in the version number information, and
manage the version number information as the multidimensional cube with a new version number.

6. A data analysis processing method comprising:
causing at least one processor of a computer to accumulate data pieces embodying a real-world event in a multidimensional cube constructed for each subject in association with an identifier of the event in a multidimensional database;
causing the at least one processor to manage, in the multidimensional cube, data of a time dimension, data of a spatial dimension, data of a plurality of types of intrinsic dimensions, and data representing characteristics of a plurality of types together with version number information including information of a version number and a configuration of the multidimensional cube;
of causing the at least one processor to execute an online analytical processing (OLAP) operation on the multidimensional cube in response to a request from a client; and
causing the at least one processor to manage generation history information including information on a process of generating a multidimensional cube of a new version number in a case where the multidimensional cube of the new version number is generated by the OLAP operation.

7. (canceled)

8. A non-transitory computer-readable medium storing program instructions that, when executed, cause one or more computers to perform operations comprising:
accumulating data pieces embodying a real-world event in a multidimensional cube constructed for each subject in association with an identifier of the event;
managing, in the multidimensional cube, data of a time dimension, data of a spatial dimension, data of a plurality of types of intrinsic dimensions, and data representing characteristics of a plurality of types together with version number information including information of a version number and a configuration of the multidimensional cube;
executing an online analytical processing (OLAP) operation on the multidimensional cube in response to a request from a client; and
managing generation history information including information on a process of generating a multidimensional cube of a new version number in a case where the multidimensional cube of the new version number is generated by the OLAP operation.
